(19) United States
(12) Patent Application Publication
(10) Pub. No.: US 2020/0366964 A1
(43) Pub. Date: Nov. 19, 2020

(54) DEVICE FOR INTERACTING WITH AUDIOVISUAL

(71) Applicant: David ALBALA CARDEMIL, LA REINA (CL)

(72) Inventor: David ALBALA CARDEMIL, SANTIAGO (CL)

(21) Appl. No.: 16/945,155

(22) Filed: Jul. 31, 2020

Related U.S. Application Data
(63) Continuation of application No. PCT/IB2019/050920, filed on Feb. 5, 2019.

(51) Int. Cl. H04N 21/478; H04N 21/472; H04N 21/8545; H04N 21/4363; H04N 21/435

(52) U.S. Cl. CPC H04N 21/47815; H04N 21/47217; H04N 21/435; H04N 21/43637; H04N 21/8545

(57) ABSTRACT

We herein provide a new device for interacting with audiovisual contents, in ways that were never tried in the past.

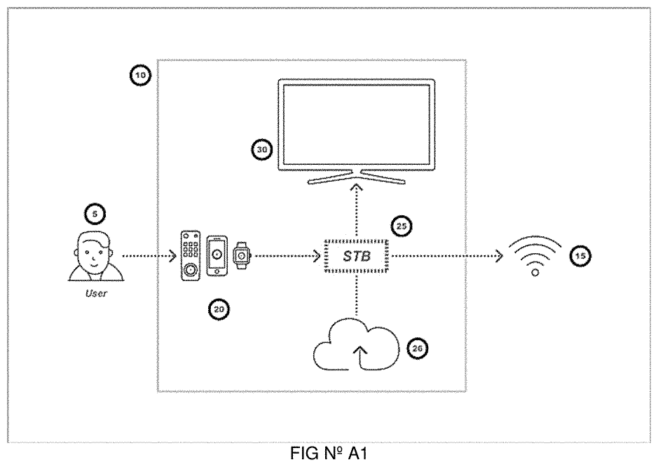

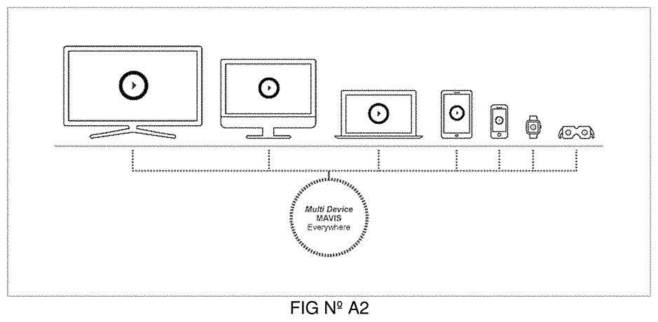

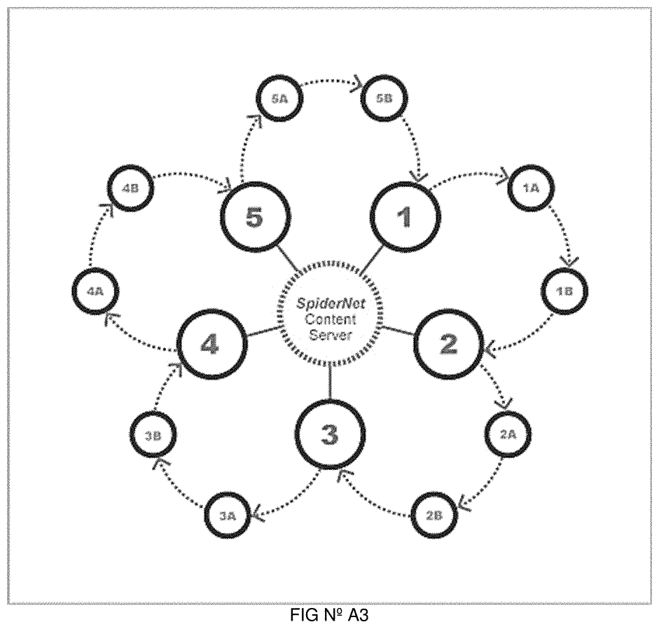

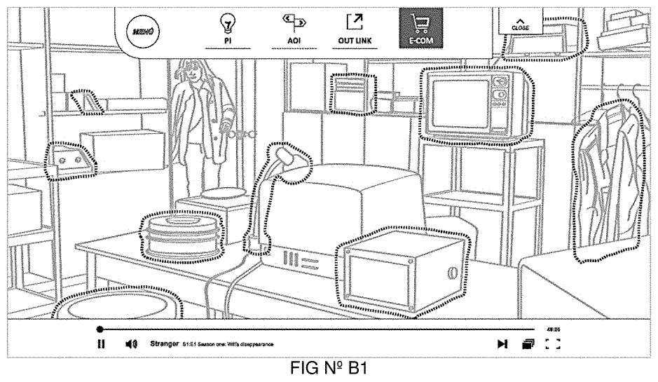

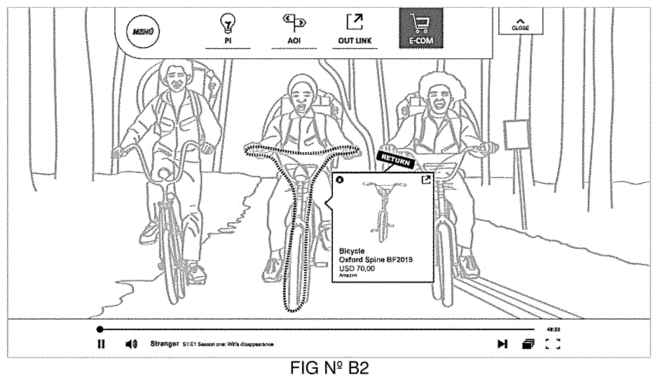

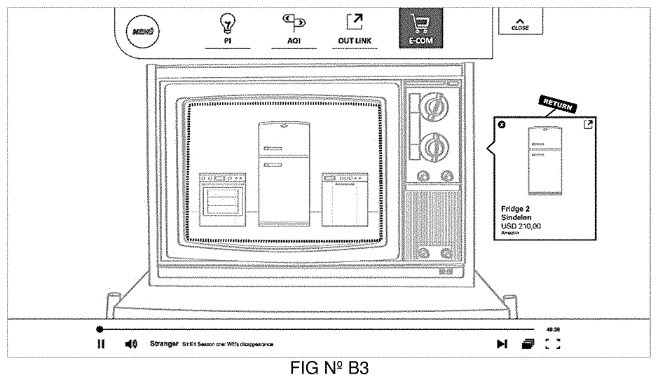

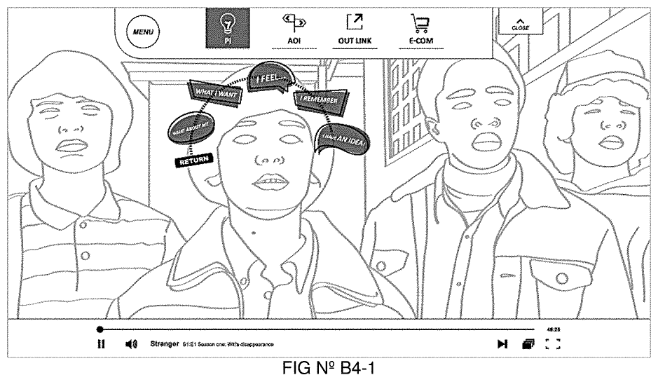

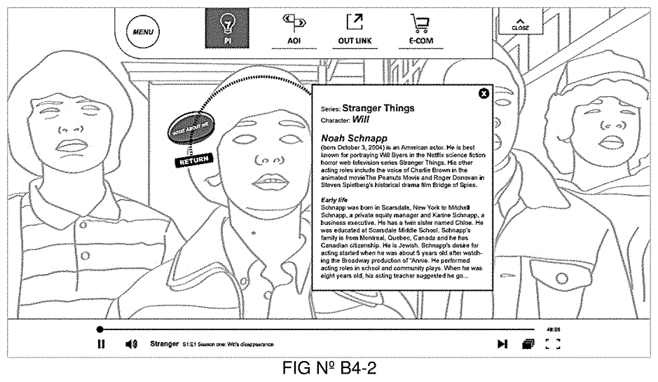

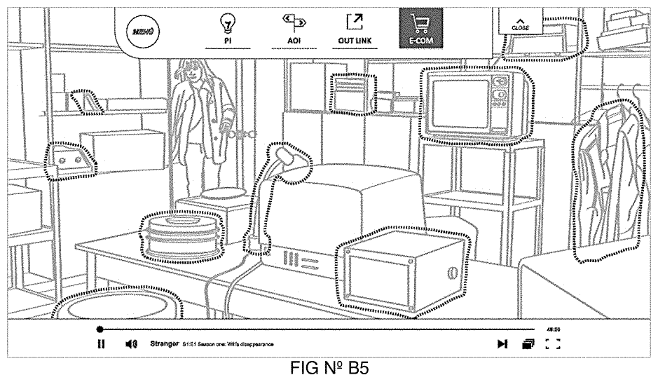

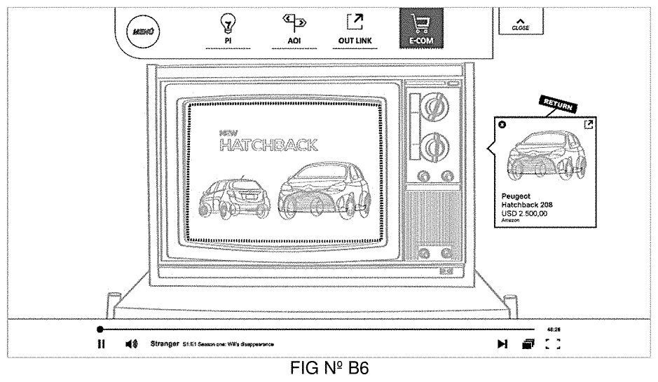

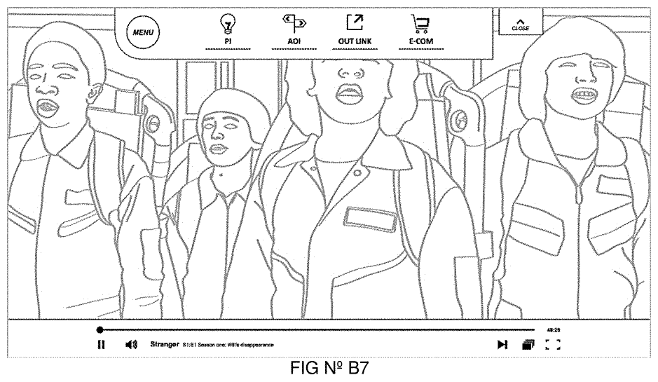

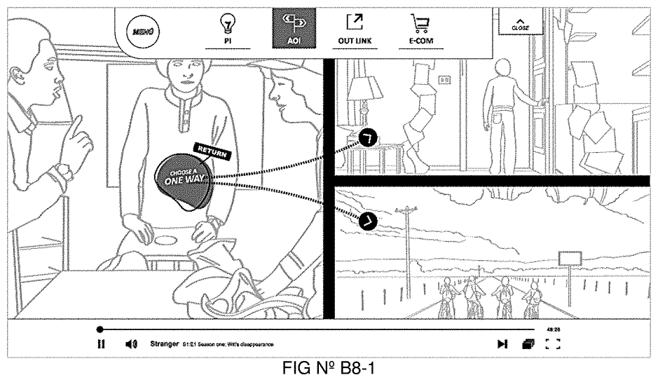

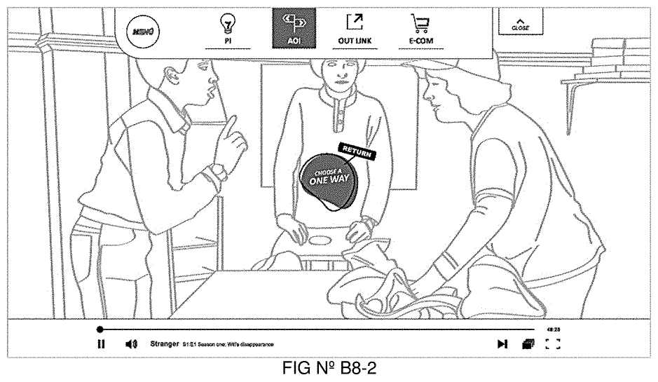

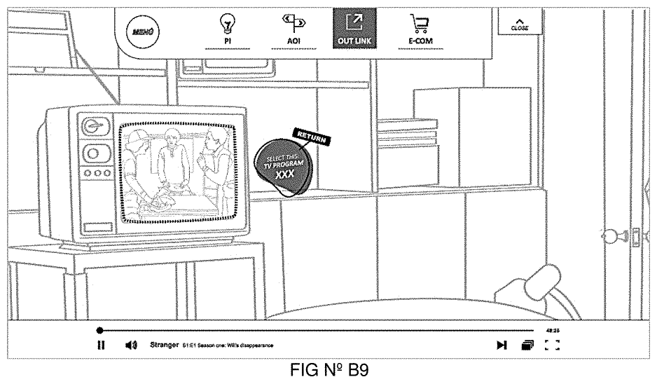

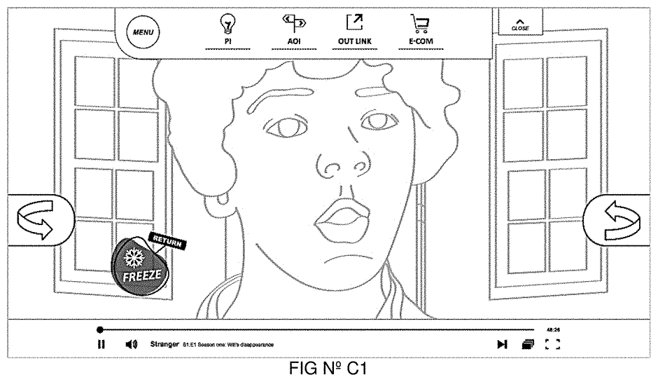

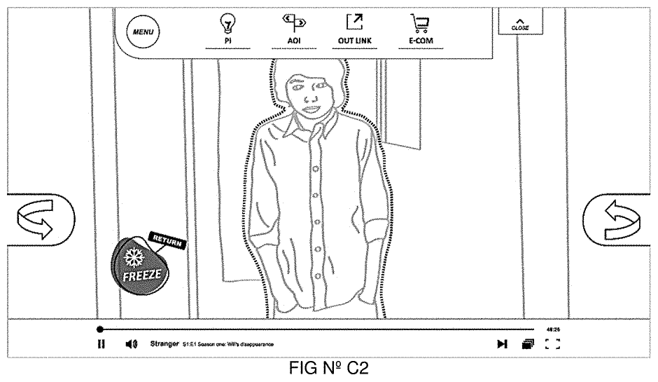

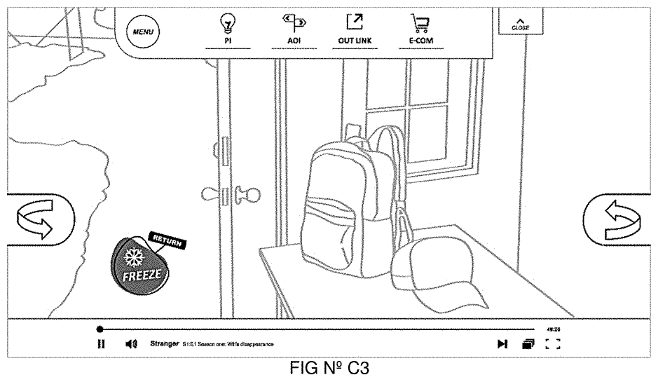

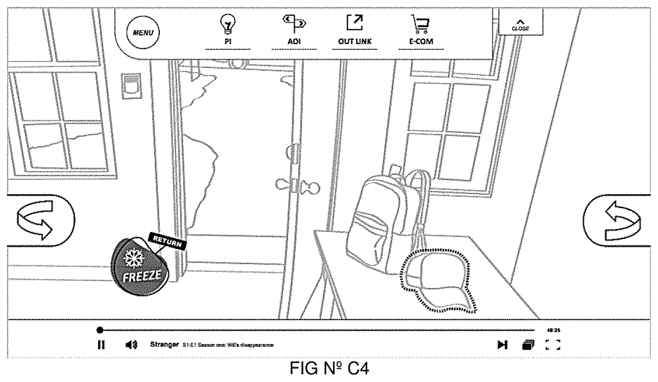

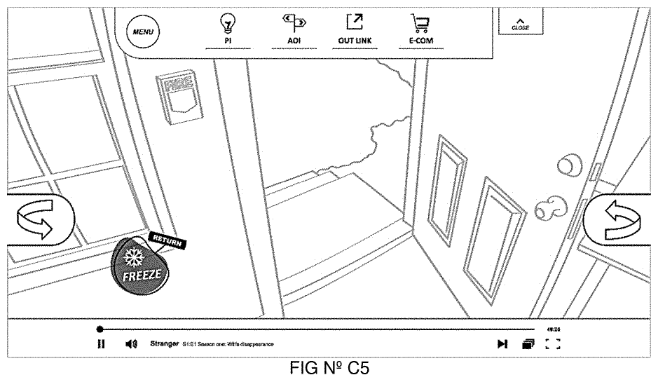

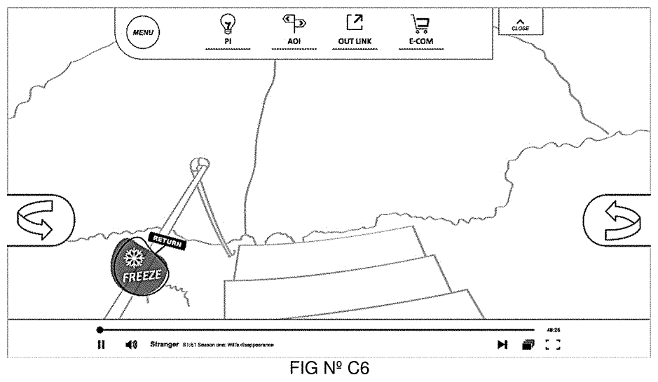

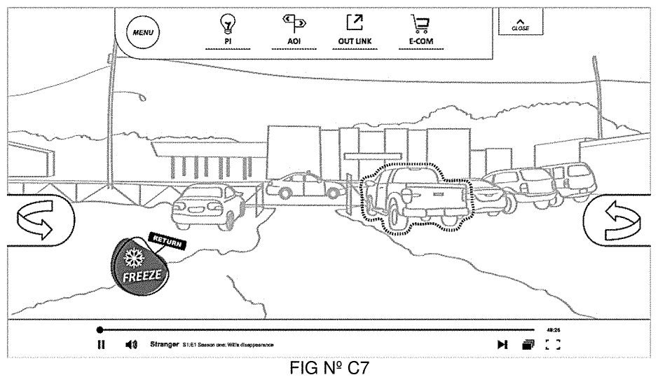

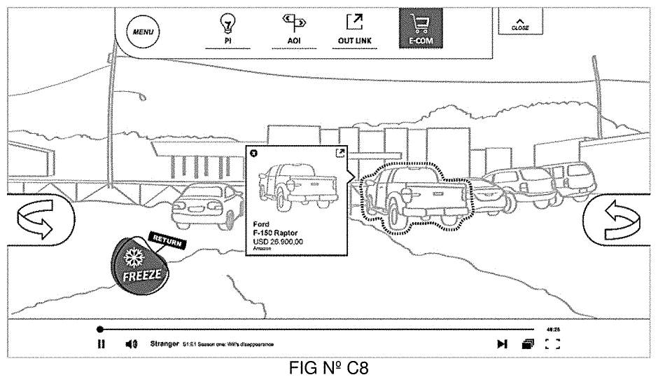

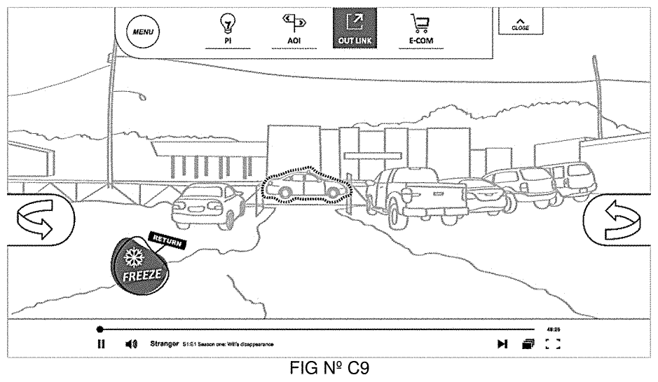

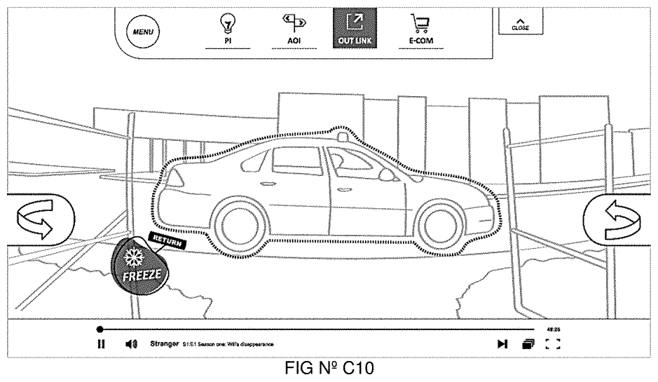

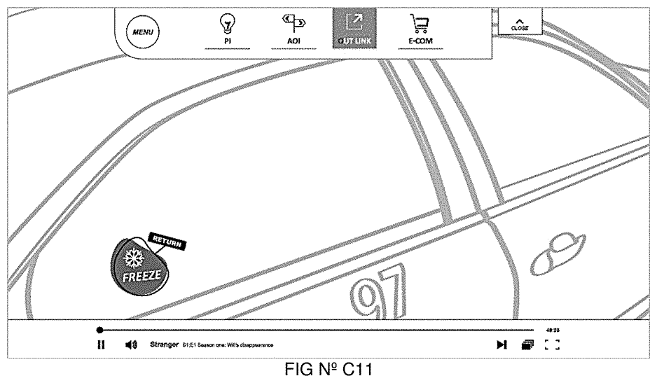

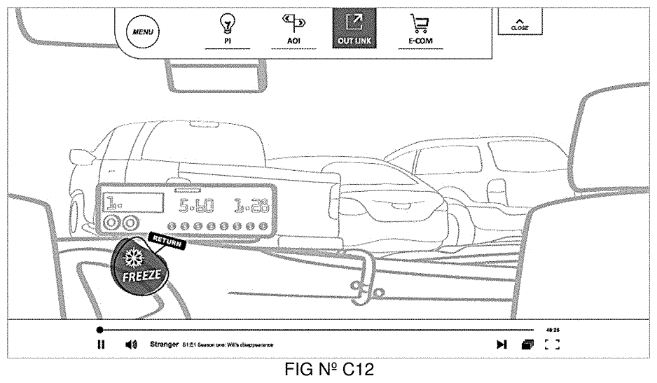

### BACKGROUND OF THE INVENTION

Sanchez (U.S. Patent Publication No. 2002/0194604) is considered to be a relevant patent reference. Sanchez discloses an “Interactive Television Virtual Shopping Cart”, comprising an interactive television system that includes a broadcast stream, which has been tagged with information describing products and/or services, which may be purchased by a viewer of the television system. When broadcasting the stream to the viewer, an icon may be presented to the viewer to indicate that information is available regarding a tagged product or service. By selecting the icon, the viewer may store information relating to the tagged product or service in a virtual shopping cart.

A virtual channel may be displayed at a later time which collates the contents of the virtual shopping cart such that the viewer may select any such products or services for purchase. The shopping cart may also be edited to add or remove any products or services therein. Purchases may be made over the Internet of any products or services stored within the virtual shopping cart by the viewer.

However, this reference still does not illustrate all of the features of the invention. In particular, this reference does not teach or suggest a system which provides information related to contextual or hidden objects within a broadcasted stream of content. While this reference does allow the purchase of items visible on the viewer device, it does not allow for retrieval of information related to items which are hidden from view or contextual items, such as the location shown on screen. Additionally, this reference does not permit the ability to move through a paused scene to locate and select tagged objects to retrieve information regarding the same. This reference is solely limited to the purchase of items which are viewed on the screen, by transferring those items to a virtual shopping cart that is visible on a separate screen and not incorporated into the display of the broadcasted content.

This reference does not disclose all of the features of the Television Interaction Software System nor would it be obvious to construct the Television Interaction Software System as disclosed in view of this reference by itself, or in combination with any of the other located references.

Dimitrova (U.S. Pat. No. 8,261,306) is also considered to be a relevant patent reference. Dimitrova discloses a “System for and Method of Shopping Through Television”, comprising a video device which displays products of interest to a viewer while viewing a displayed program such as a television program. The user may select any such products of interest directly on the screen of the video device to receive information relating to the product. The user may select such a product by pressing a point on the screen, by audio command, or by interaction with a remote control. The user may indicate a price, quantity, or time frame within which the user wants to purchase the product. The system may display to the user the current price and availability of the product and, upon a command from the user, automatically purchase the product. If the price is too high at that time, the user may store the product in a wish-list to be purchased at a future time when the price reaches a desired level.

However, this reference still does not illustrate all of the features of the invention. In particular, this reference does not teach or suggest the retrieval of information relating to hidden or contextual objects within a broadcasted stream of content on a display device. Instead, this reference relates to the purchase of objects which are visible on the screen and does not include location information of a setting displayed on the screen or the purchase or retrieval of information related to hidden objects. Additionally, this reference does not allow a user to move through a frozen or paused scene to seek out tagged objects to purchase or retrieve information regarding. This reference does not disclose all of the features of the Television Interaction Software System nor would it be obvious to construct the Television Interaction Software System as disclosed in view of this reference by itself or in combination with any of the other located references.

Billmaier (U.S. Pat. No. 7,237,252) is also considered to be a relevant patent reference. Billmaier discloses a “Method and Apparatus to Invoke a Shopping Ticker”, comprising a system which allows the display of a shopping ticket on a viewing device such as a television during broadcast of content such as a television program. The viewer may select a button on his/her remote while content is being streamed on the viewing device. Upon selecting the button, a shopping ticker may be displayed in an overlay or on the border of the broadcasted content. The shopping ticker may include advertisements, links to websites, product information, or other information. The user may purchase anything from the shopping ticker directly using his/her remote control.

However, this reference still does not illustrate all of the features of the invention. In particular, this reference does not teach or suggest the ability to purchase or retrieve information relating to contextual or hidden objects. This reference appears limited to the purchase of items which are visible on the screen itself and not objects which may be hidden from view or the retrieval of information relating to the location shown on the screen. This reference additionally does not teach or suggest the pausing of the display to allow a user to move through the scene to select such tagged objects for information retrieval or purchase.

This reference does not disclose all of the features of the Television Interaction Software System nor would it be obvious to construct the Television Interaction Software System as disclosed in view of this reference by itself or in combination with any of the other located references.

### BRIEF DESCRIPTION OF THE DRAWINGS

FIG. A1: shows that MAVIS is a TI platform to watch video contents.

FIG. A2: shows that a user can access to MAVIS by any kind of devices.

FIG. A3: describe how could set the contents chains in a kind of “spidernet”. It shows that contents 1 connects to 1A, and then contents 1A connects to 1B. Likewise, 1B connects to content 2 and so on.

FIG. B1: shows that a user can buy anything objects or accessories that appear on a scene.

FIG. B2: shows that a user can buy any objects and/or accessories that it's been using or interact with a character.

FIG. B3: shows that a user can buy or get information of any objects and/or accessories that appear in a commercial that it's been showing in a TV set in the scene.

FIG. B4-1: shows that a user can know or obtain information about personal data of any living being or character on the stage.

FIG. B4-2: shows that a user can know or obtain information about personal data of any living being or character on the stage.

FIG. B5: shows that a user can buy anything objects or accessories that appear on a scene.

FIG. B6: shows that a user can buy or get information of any objects and/or accessories that appear in a commercial that it's been showing in a TV set in the scene.

FIG. B7: shows that a user has a browser available with a menu with different type of interactive functions.

FIG. B8-1: shows that a user can choose some actions that the character to perform.

FIG. B8-2: shows that a user can choose to return at the moment that decide one way instead another. If the user returns to the same moment, now, could choose the other options to perform by the character.

FIG. B9: shows that a user has available an interactive function denominate “Out Link” (OL), that allow to access to another program that is inside of it.

FIG. C1 to C8: shows that a user has available an interactive function that stop or “freeze” all the environment of a scene. The user can move and explore around and buy anything.

FIG. C9 to C12: shows that a user has available an interactive function denominate “Out Link” (OL), that allow to access to another program that is inside of it.

### SUMMARY OF THE INVENTION

The invention relates to a device executing a computer program, intended to be deployed on TV devices, which permits the user to interact with a plurality of previously tagged objects, such as shown in FIG. A1 and FIG. A2.

Particularly, the user may stop the playback of the program to interact with the tagged objects, or may interact with them during playback.

Particularly, the user may be allowed to move through the “frozen” stage, as if he/she were there, and may perform a plurality of actions with the tagged objects, such as obtaining information.

In FIG. B1, it is shown that the tagged objects are visible, hidden, or contextual, for instance, objects inside the purse of a person in the stage (hidden), or the location of the stage (contextual).

In FIG. B2, it is seen that, generally, any tagged object has a predefined plurality of actions which the user may interact with.

In FIG. B3, for example, an object may contain information about Name, Price, Technical Information, Places where to buy the object, or even buy directly the item, etc.

In another aspect, in FIG. B4-1 and FIG. B4-2 it is shown that the user may obtain information about personal data of any living being in the stage, such as name, preferences, hobbies, feelings, etc.

### DETAILED DESCRIPTION OF THE INVENTION

Provided is a computing device running a method, that will be known as Multimedia Audiovisual Interactive System (MAVIS).

It involves the development and implementation of a TI platform for the management and control of all types and all kind of audiovisual contents created under a new concept, and also a new production methodology named “InteracNet-TV”, that allows the spectator/viewer/user to experiment with a new audiovisual format.

The invention comprises a computing device executing a computing method, wherein a user may perform the steps of:

a) provide an interactive first audiovisual content containing a plurality of different kind of tagged objects of different kinds, wherein each object may be one of:
another audiovisual content;
a character;
an accessory;

b) tag each tagged object with a redefined plurality of actions which the user may interact with, wherein an action is an action that involves exchange of information, value, or both, between the user an the audiovisual content;

c) start the first audiovisual content;

d) interact with the audiovisual contents, or any in the plurality of objects, wherein the user may choose one of these:
virtually move through the stage as if the user was there;
execute an action included in a tagged object.

An exemplary embodiment is shown in FIG. B7 (BROWSER), having a plurality of features to interact with, including audiovisual contents of any kind of format or genre, such as (to name but a few):
animation
commercial spots
docu-fiction
documentary
docu-reality
educational
eLearning
fiction
infomercials
late shows
movies
music videos
reality
sitcoms
soap operas
spot commercials
talk shows
theater movies
TV movies
TV series
virals

MAVIS allows, such as shown in FIG. B5, also to associate the e-commerce of a great variety of products and/or accessories incorporated to each one of the programs according to its nature and type, independent of its format or genre, being able the user to buy any kind of objects and accessories that user sees in each and all scenes and/or everything that the characters uses, dresses, carries or forms part of its personality or back story that appears in each program, regardless the character being fictional (narrative) or real (exist in real life).

More particularly, the tagged objects are visible, hidden, or contextual.

Further, the user may stop the playback of the program to interact with the tagged objects, or may interact with them during playback.

Furthermore, the plurality of actions with the tagged objects is any of:

obtain information of an object, such as person information, object information;

trade the object.

Moreover, person information comprises personal data of any living being in the stage, such as name, preferences.

Additionally, the object information may be one or more of: Name, Price, Technical Information, Places where to buy the object, or even buy directly the item, etc. MAVIS allows, such as shown FIG. B6, to display advertising in an enhanced way, since it allows to user buy on line what the spot is exhibiting. The system, as well, allows to create, and associate any kind of gamification in each program.

Furthermore, the invention may be deployed in such a way that, a main computing device is wirelessly connected to a second group of computing device, wherein the main computing device mirrors the audiovisual contents to the second group of computing devices, such that a user using one of the second group of computing devices is able to interact with the audiovisual contents in his own device.

The above would be useful, for example, in theaters, where the user may buy items that are shown during a movie being projected, without affecting other users. The mirroring may be done using conventional or other kind of wireless methods, including those to be invented, such as:
Wi-Fi
Bluetooth

In the invention, the computing device and/or the computing devices of the second group may be deployed in any kind of computing device, such as:
gaming consoles
home computers
laptops
mobile phones
movie theaters
smart TVs
tablets

In another aspect, the action of buying an item may be done by hovering over item and clicking on the item.

In yet another aspect, the user may tag an item for use later.

In another option, the user may create a “bookmark” in the audiovisual contents. FIG. A2.

Particularly, as a user of any kind of MAVIS contents, the user will be able to: Make decisions about the narrative progression of the story that is being show in the audiovisual contents.
a) As shown in FIG. B8-1, to choose some actions (ACTION OPTION INTERLINK—AOI) that the user wants the characters of any program to perform, within a spectrum of alternatives. For example, the user may select what the character will do or do not in a scene; to say or not; to go or not; in each scene, to name but a few.
b) As shown in FIG. B8-2, to choose different endings of a story within a spectrum of alternatives.
c) As shown in FIG. B4-1 and FIG. B4-2, to enter to the mind of any character (PONDER INTERLINK—PI) and discover a plurality of predefined thoughts, feelings, tastes, motivations, and personal secrets, to name but a few. Things that the character does not say or expose explicity to another character or, instead, to audience. For example, the user may obtain a flashback memory and discover how was or what kind of experience had the character in the past.
d) As shown in FIG. C1 TO FIG. C8, to choose to stop the program and freeze everything is happening in the scene, leaving the characters immobile, animators or interviewees. Then, the user can explore around the room or place in which is occurring the scene. The user can make a 360° view, while the characters, animators or interviewees remain motionless. Moreover, the user also can go out of the room or place in what is set up the scene and, now, explore others rooms or places that are adjacent locations while everything stays frozen.
e) As shown in FIG. C1 TO FIG. C8, choose to stop the program and freeze all around leaving the characters immobile, animators or interviewees. Then, the user can move around the TV studio, the set of the scene or the house of the character; or, if the user prefers, leave the TV studio, set or house taking any direction he want, for example, to the garden or to the street, while the whole environment remains frozen.
f) As shown in FIG. C1 TO FIG. C8, to check what the characters carry in their pockets, the brand of clothes they wear or their accessories, and purchase them online just by selecting directly what is part of a scene of any program.
g) To view and buy from a plurality of predefined items, wherein this plurality of predefined items may be composed of the respective set of items of each character, animator or interviewee, by accessing, for instance, predefined individual closets, for each character, animator or interviewee, in which the user may find a list of clothes they wear, a list of accessories they use, a list of music they listen, a list of books they read, a list of movies they like, a list of food they eat, as well as other products and services that describe and fit the personality of each one, to name but a few FIG. B2 (E-COM)
h) To buy the soundtracks and original music that part of the any content or any kind of program.
i) To choose to return to the starting point of the scene and exit of the “freeze” option and re-run the program that the user was watching in the first place. j) The user, while watching a program, can make other decisions like, for example: if in a scene there is a TV set, in which another program is being given, the user can select to see that program. Thus, the user may enter to see a program that is “inside” the one that was seeing in the first place. MAVIS allows to organize and distribute the programs, so that a program can be accessed and then to “other programs” that are “inside” the first ones. To illustrate it more, as with “Matrioshkas” dolls of the Russian craft tradition, which in their interior houses smaller ones. FIG. B9 (OL 1), FIG. C9 (OL 2) to FIG. C12 (OL 2).
k) The user of any kind of MAVIS content, as shown in FIG. A2, can make all the interactions described above using the remote control as a “joystick” and also using real-time voice recognition language by just looking at a device.

MAVIS allows the user, as shown in FIG. A3, to recreate an “infinite” and interactive audiovisual universe, since the user enters, sees and plays in one program, and then can penetrates in another that is inside the first one that entered in the first time. Thus, a “program network” (called “SpiderNet”) is provided, which consists of as many programs or content as the production company may desire.

As shown in FIG. A2, all programs networks (“SpiderNet”) will be able to be viewed on line and/or downloaded to the hard drive of a PC or Smart TV to be explored from there.

As shown in FIG. B8 (BROWSER), all these features of MAVIS provides for a new form of content creation and marketing, since these must be designed and built for the MAVIS's format. Nevertheless, an unpublished programmatic proposal will be achieved, capable of creating spaces of audiovisual contents with multiple dimensions in which an user can submerge, interact, and buy at will.

Particularly, in the field of education and e-learning, MAVIS can implement a new way of viewing distance education, in which users can modify their way of studying, selecting contents according to their own needs, for example choosing not only the subject to study, also to select the teacher that most likes, the classroom, to stop the class if something is not clear to him, and to go to look for more information, to the web, to the CD of support, or if he prefers to go to the virtual library.

MAVIS thus provides a new way of audiovisual production that will combine the methodologies of work of video games and the traditional cinema and television production.

1. A computing device executing a computing method, said method performing steps of:
a) provide an interactive first audiovisual content containing a plurality of different kind of tagged objects of different kinds, wherein each tagged object may be one of:
another audiovisual content;
a character;
an accessory;
b) wherein the user may interact with each tagged object by a plurality of actions, involving exchange of information, value, or both;
c) start the first audiovisual content;
d) interact with the first audiovisual content, or any in the plurality of different kind of tagged objects, wherein the user may choose one of these:
virtually move through a stage as if the user was there;
execute an action included in a tagged object.

2. A computing device as claimed in claim 1, wherein one or more of the plurality of different kind of tagged objects are visible, hidden, or contextual.

3. A computing device as claimed in claim 1, wherein the user may stop the playback of a program to interact with the tagged objects, or may interact with them during playback.

4. A computing device as claimed in claim 3, wherein the plurality of actions with the tagged objects is any of:
obtain information of an object, such as person information, object information;
trade the object.

5. A computing device as claimed in claim 4, wherein person information comprises personal data of any living being in the stage, such as name, preferences.

6. A computing device as claimed in claim 5, wherein the object information comprises: Name, Price, Technical Information, Places where to buy the object, or buy directly the item, etc.

7. A computing device as claimed in claim 6, wherein the first audiovisual content, or any of the audiovisual contents included in a tagged object, are selected within a group of:
animation
commercial spots
docu-fiction
documentary
docu-reality
educational
eLearning
fiction
infomercials
late shows
movies
music videos
reality
sitcoms
soap operas
spot commercials
talk shows
theater movies
TV movies
TV series
virals.

8. A computing device as claimed in claim 7, wherein the action of buying an item is done by hovering over the item and clicking on the item.

9. A computing device as claimed in claim 8, wherein the user tags an item for use later.

10. A computing device as claimed in claim 9, wherein the user creates a “bookmark” in the first audiovisual content, or any of the audiovisual contents included in a tagged object.

11. A computing device as claimed in claim 10, wherein the first audiovisual content, or any of the audiovisual contents included in a tagged object, are mirrored to a second group of one or more computing devices.

12. A computing device as claimed in claim 11, wherein the audiovisual contents are mirrored via Wi-Fi, Bluetooth or other wireless method.

13. A computing device as claimed in claim 12, wherein the computing device and/or the computing devices of the second group are selected within a group of:
gaming consoles
home computers
laptops
mobile phones
movie theaters
smart TVs
tablets.
